(19) United States
(12) Patent Application Publication
(10) Pub. No.: US 2005/0237201 A1
(43) Pub. Date: Oct. 27, 2005

(54) Method of tracking bulk quantities of products

(76) Inventor: Jeffrey B. Nedblake, Parkville, MO (US)

Correspondence Address: Hovey Williams LLP, Suite 400, 2405 Grand Blvd., Kansas City, MO, 64108, US

(21) Appl. No.: 10/818,965

(22) Filed: Apr. 6, 2004

(51) Int. Cl. G08B 13/14

(52) U.S. Cl. 340/572.8; 340/5.92; 235/385; 700/215

(57) ABSTRACT

A method of tracking and identifying a plurality of items using a label containing an electronic article surveillance (EAS) device such as an RFID tag. An EAS device-containing label is attached to at least one, but less than all, of the items. At least one identifying indicium is stored on the EAS device pertaining to the plurality items.

### BACKGROUND OF THE INVENTION

1. Field of the Invention

The present invention is directed toward a method of identifying a plurality of items using labels containing electronic article surveillance (EAS) devices. More specifically, the method pertains to forming a packaging unit comprising a plurality of items, at least one but less than all of which have a label containing an EAS device applied thereto.

2. Description of the Prior Art

The tracking and identification of products from the manufacturer to the retailer is an important and vital business operation. In the context of large retailers, knowing exact quantities of inventory and where it is located at any given time is essential to the proper distribution of goods throughout its retail network. Furthermore, tight inventory control has the added benefit of deterring theft of goods during the distribution process.

EAS devices have been employed to assist in theft prevention at the retail level for many years. EAS devices are applied to individual items and are then removed or deactivated upon purchase of a particular item. If the consumer attempts to remove the item from the store while the EAS device is active, sensing equipment usually located proximate the store exit detects the active EAS device and sounds an alarm. This method of product monitoring has the disadvantages in that the EAS device is oftentimes visible to the potential thief who may remove it from the product prior to exiting the store thereby circumventing the EAS security system. Furthermore, application of the EAS devices to the product can damage the overall aesthetics of the product.

Radio frequency identification (RFID) tags have the capability to store information related to a product on an integrated circuit. The information is retrieved through an RFID interrogation device. Applying RFID tags to individual devices has the drawback of being relatively expensive in that the tags themselves can be costly and numerous checks must be performed through the manufacturing and tag application process to prevent application of a defective tag to a product.

There is a real an unfulfilled need in the art for a method of tracking and identifying items which is less expensive than application of RFID tags to each individual product and less susceptible to circumvention by would-be thieves.

### SUMMARY OF THE INVENTION

The present invention overcomes the above problems and provides a method of identifying and tracking a plurality of items and comprises applying a label containing an EAS device to at least one but less than all of the items. The items are then combined into a packaging unit. The EAS device contains at least one indicium capable of identifying the plurality of items or identifying a characteristic of the items. RFID tags are especially preferred EAS devices for use with the invention.

In particularly preferred embodiments, the RFID tag is programmed (i.e., the indicium capable of identify the items is written or provided to the tag) prior to the application of the label to the item. Alternatively, the programming step occurs at some point after the label has been applied to the item, but preferably prior to combining the items into a packaging unit.

An RFID interrogating device is used to retrieve the identifying indicium contained on the RFID tag. Preferably, the RFID tag stores at least one piece of data related to the items such as a serial number which is associated with an actual description of the items that is stored in a remote database, an actual description of the items, the date of manufacture of the items, the present location and/or destination of the items, or the quantity of items present in the packaging unit.

The present invention is particularly useful in the tracking and identification of packaging units containing bulk quantities of items throughout the manufacturing and distribution stages of the items. In one aspect, a plurality of products are packaged together in a common container. At least one but less than all of the products has a label containing an EAS device (preferably an RFID tag) applied thereto. The EAS device on the at least one item contains an identifying indicium related to the plurality of products. At any stage during the manufacturing and distribution stages, the EAS device may be interrogated in order to retrieve the indicium contained thereon.

In another aspect, the packaging unit comprises a plurality of containers, each of which contains a plurality of individual products. In this aspect, at least one but less than all of the containers has a label including an RFID tag applied thereto. In particularly preferred embodiments, none of the individual products have RFID tags applied thereto. In this manner, large quantities of products may be tracked and identified efficiently and cost effectively without the need for placing an EAS device on each individual product.

Systems for identifying a plurality of items in accordance with the present invention comprise a packaging unit comprising a plurality of items, at least one but less than all of the items having a label containing an RFID tag applied thereto, and an RFID tag interrogating device capable of interrogating the RFID tag. The RFID tag contains at least one indicium capable of identifying the plurality of items. The interrogating device is operable to retrieve the at least one indicium contained on the RFID tag. Preferably, the packaging unit comprises a plurality of individual products placed in a common container. However, in certain preferred embodiments, the packaging unit comprises a plurality of containers, each of which contains a plurality of individual products. In such instance, preferably none of the individual products inside the containers have RFID tags applied thereto.

The present invention has the advantage in that it is not necessary to apply RFID tags to each individual item thereby resulting in significant cost savings. Furthermore, circumvention of security systems by placing the RFID tag on a product inside a container is much more difficult as the container would need to be opened and the at least one product containing the RFID tag identified. As the RFID tag is preferably applied to the product label, such identification would require close inspection of each item.

### BRIEF DESCRIPTION OF THE DRAWINGS

FIG. 1 is a schematic diagram of an apparatus for selective application of EAS devices to labels and application of the labels to products.

FIG. 2 is a cut away view of a plurality of products packaged in a common container, showing that at least one but less than all of the products bears and RFID-containing label.

FIG. 2A is a close-up view of a product from FIG. 2 that bears an RFID-containing label.

FIG. 3 is a drawing of a plurality of packages placed on a pallet, at least one but less than all of the packages has an RFID-containing label affixed to the outside thereof.

FIG. 3A is a close-up view of a package from FIG. 3 that bears an RFID-containing label.

### DETAILED DESCRIPTION OF THE DRAWINGS

The following description sets forth preferred embodiments of the present invention. It is to be understood, however, that this description is provided by way of illustration and nothing therein should be taken as a limitation upon the overall scope of the invention.

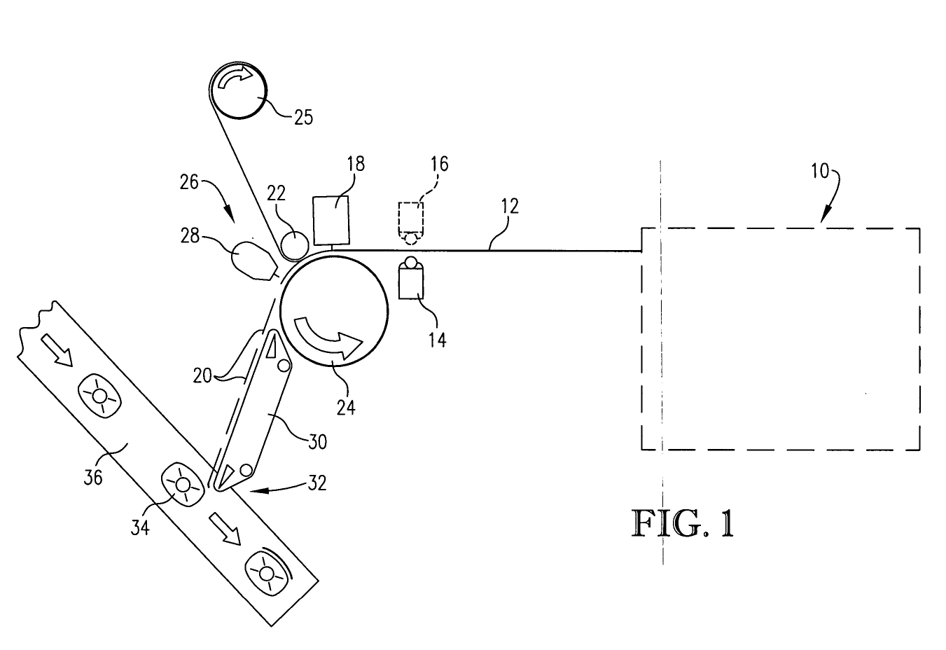

Turning now to the drawings, and in particular FIG. 1, a method of selective application of EAS device-containing labels to products is shown. A web supply station 10 is provided. In certain embodiments, station 10 may simply comprise a continuous web of printed images, from which labels may be cut. Station 10 may also comprise a system for on-demand production of printed images. Examples of such on-demand systems are illustrated in U.S. Pat. No. 6,598,531 and U.S. patent application Ser. No. 10/365,167, both of which are incorporated by reference herein.

A continuous web 12 of pressure sensitive material having images printed thereon exits station 10 and is fed past an image sensor 14. Sensor 14 optically scans each image printed on the label in order to determine whether that particular image is defective in some manner. Optional sensor 16 may also be provided to examine the opposite side of web 12 for defects. Web 12 continues to a laser cutting device 18. Cutting device 18 receives a signal from sensor 14 and/or sensor 16 instructing device 18 to cut or not to cut the particular image that is before it. Device 18 then selectively laser cuts the images from web 12 thereby forming individual cut labels 20. The direction of travel of web 12 is changed as web 12 is directed around roller 22. Cut labels 20 adhere to drum 24, which may be either a vacuum or static drum while web 12 is taken up onto waste roll 25. Drum 24 directs labels 20 past EAS device application station 26 where EAS device applicator 28 applies an EAS device, preferably an RFID tag, to at least one but less than all of the labels directed past station 26. Applicator 28 may be pre-programmed so that it applies an EAS device to labels randomly or at fixed intervals, such as to every 3^{rd}, 6^{th}, or 12^{th} label. Cost savings are realized with the present invention in that at least some labels 20 do not receive an EAS device.

It is to be understood that it is also within the scope of the present invention to provide a pre-fabricated roll of labels having EAS-devices attached to at least one but less than all of the labels contained therein. The EAS-devices may be applied to the labels randomly or at fixed intervals.

Labels 20 are then transferred to a belt device 30 (static or vacuum) for transport to a label application station 32. A plurality of products 34 are provided on conveyor 36 and directed toward station 32 where labels 20 are applied to products 34. The labeled products 34 are then sent to a packaging station (not shown) and prepared for shipping.

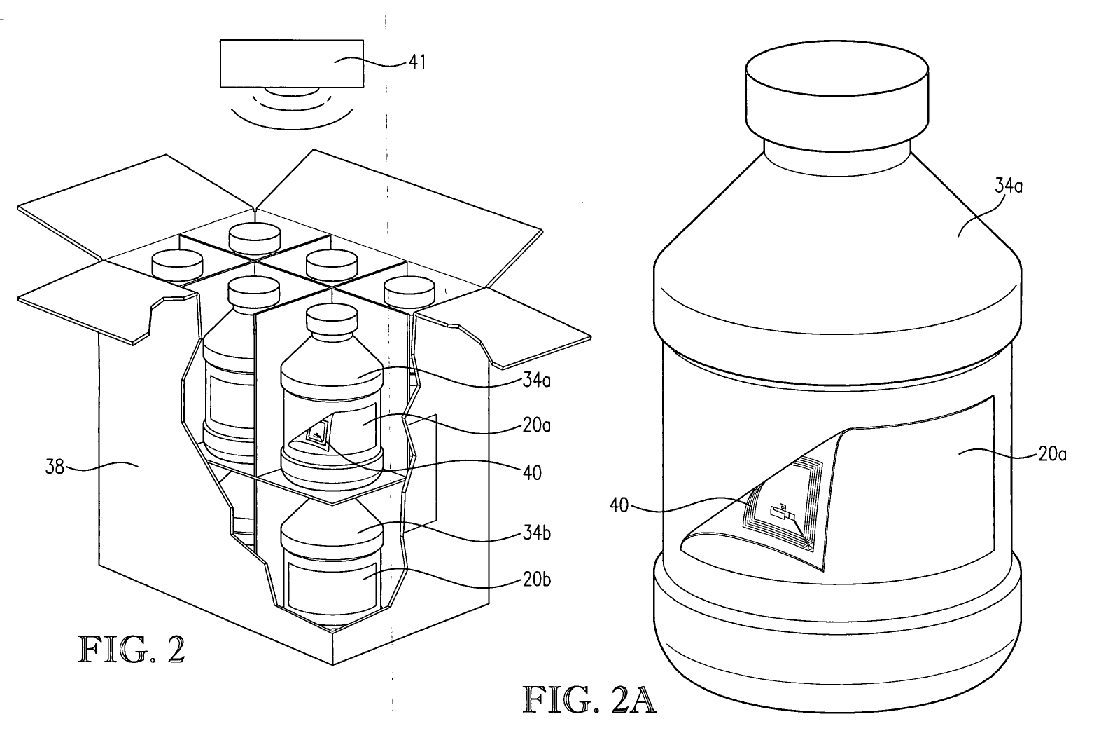

FIG. 2 shows an exemplary packaging arrangement wherein eight products 34 have been packaged in a box 38. Box 38 contains a product 34a that bears a label 20a including an RFID tag 40. Note, however, that product 34b contains a label 20b that does not include an RFID tag. RFID tag 40 contains at least one indicium for identifying the products 34 contained within box 38. The indicium may be programmed into the RFID tag circuitry prior to its application to label 20a, after its application to label 20a but prior to application of label 20a to product 34a or after label 20a is applied to product 34a. The indicium programmed may be any useful information capable of identifying the products 34 such as a serial number which is associated with an actual description of the products that is stored in a remote database, an actual description of the products, the date of manufacture of the products, the present location and/or destination of the products, or the quantity of products present in box 38.

Any time after programming of RFID tag 40, the indicum contained thereon may be retrieved by an RFID interrogator 41. For example, as box 38 is loaded onto a truck for transport to a remote warehouse, RFID tag 40 may be interrogated and the indicium noted so that the location of box 38 may be tracked. Likewise, RFID tag 40 may be interrogated upon arrival of box 38 at the warehouse and the new location of box 38 noted in a tracking system.

FIG. 2A is merely a close-up view of product 34a having an RFID tag-containing label 20a attached thereto. As shown, it is preferable for the RFID tag 40 to be flexible and present as small a profile as possible so that it is difficult to visually detect while label 20a is affixed to product 34a. The more difficult it is to identify which product bears the RFID tag-containing label 20a, the more difficult for a would-be thief to circumvent the increased security the present invention affords.

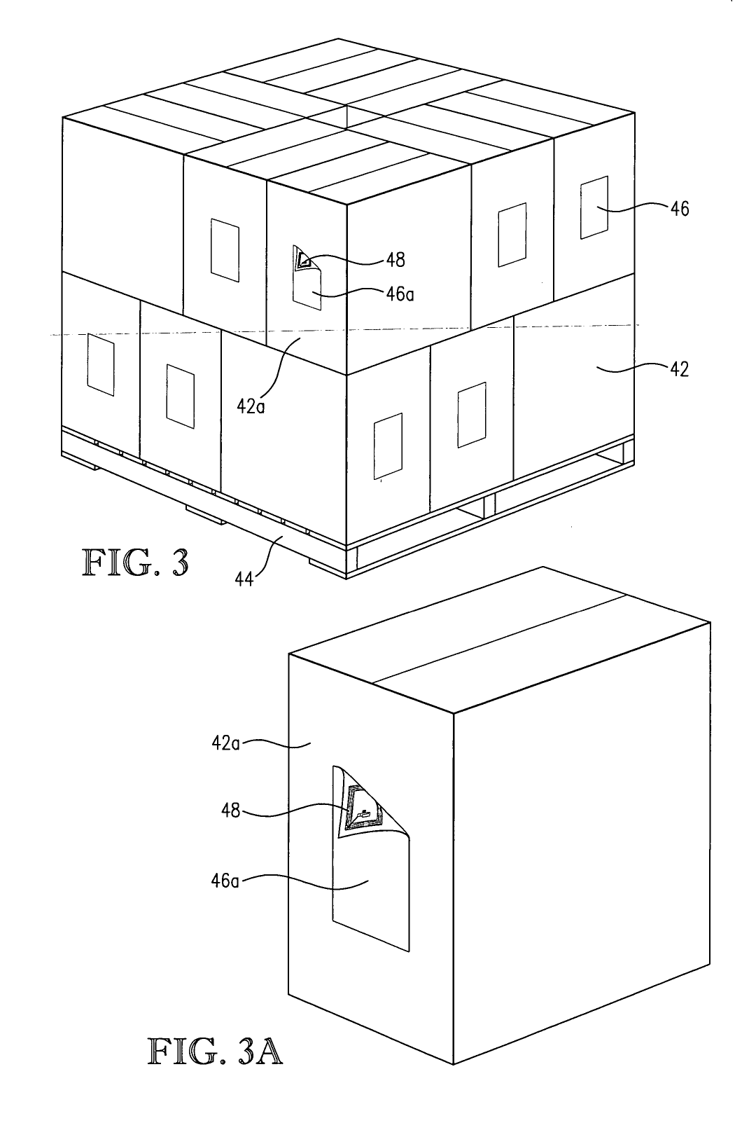

FIG. 3 illustrates yet another embodiment of the present invention. In FIG. 3, a plurality of boxes 42 are associated on a common pallet 44. Each box has a label 46 affixed to the outer portion thereof. Box 42a (see FIG. 3A for close-up view) bears an RFID tag-containing label 46a. All other boxes on pallet 44 bear labels 46 which do not contain RFID tags. The location of the entire pallet may be tracked by the RFID tag 48 contained on label 46a in a manner very similar to that described above with respect to box 38.

1. A method of identifying a plurality of items comprising the steps of:
providing a plurality of items;
applying a label containing an electronic article surveillance (EAS) device to at least one but less than all of said items; and
combining said items into a packaging unit, said EAS device containing at least one indicium capable of identifying said plurality of items.

2. The method of claim 1, said EAS device comprising an RFID tag.

3. The method of claim 2, said method further comprising the step of interrogating said RFID tag in order to retrieve said at least one indicium contained thereon.

4. The method of claim 2, said method further comprising the step of programming said RFID tag prior to applying said label to said item.

5. The method of claim 2, said method further comprising the step of programming said RFID tag after applying said label to said item.

6. The method of claim 5, said programming step occurring prior to combining said items into a packaging unit.

7. A packaging unit comprising a plurality of items, at least one but less than all of said items having a label containing an electronic article surveillance (EAS) device applied thereto, said EAS device containing at least one indicium capable of identifying said plurality of items.

8. The packaging unit of claim 7, said EAS device comprising an RFID tag.

9. The packaging unit of claim 8, said packaging unit comprising a plurality of individual products placed in a common container.

10. The packaging unit of claim 8, said packaging unit comprising a plurality of containers at least one but not all of which has a label including an RFID tag applied thereto.

11. The packaging unit of claim 10, said containers comprising a plurality of individual products.

12. The packaging unit of claim 11, none of said individual products having RFID tags applied thereto.

13. A system for identifying a plurality of items comprising:
a packaging unit comprising a plurality of items, at least one but less than all of said items having a label containing an RFID tag applied thereto, said RFID tag containing at least one indicium capable of identifying said plurality of items; and
an RFID tag interrogating device capable of interrogating said RFID tag in order to retrieve said at least one indicium contained thereon.

14. The system of claim 13, said packaging unit comprising a plurality of individual products placed in a common container.

15. The system of claim 13, said packaging unit comprising a plurality of containers at least one but not all of which have a label including an RFID tag applied thereto.

16. The system of claim 15, said containers comprising a plurality of individual products.

17. The system of claim 16, none of said individual products having RFID tags applied thereto.
